(19) United States
(12) Patent Application Publication
(10) Pub. No.: US 2026/0271818 A1
(43) Pub. Date: Sep. 17, 2026

(54) WING LOCK FOR AGRICULTURAL IMPLEMENT

(71) Applicant: CNH Industrial Brasil Ltda., Nova Lima (BR)

(72) Inventor: Leonardo Reis Menezes, Piracicaba (BR)

(21) Appl. No.: 19/562,964

(22) Filed: Mar. 11, 2026

(30) Foreign Application Priority Data
Mar. 11, 2025 (BR) 10 2025 004560 5

(51) Int. Cl. A01B 63/10; A01B 61/00; A01B 76/00; F16C 11/04

(52) U.S. Cl. CPC A01B 63/10; A01B 61/00; A01B 76/00; F16C 11/04

(57) ABSTRACT

A pivotal coupling assembly for a wing of an agricultural implement includes a wing lock pivotally coupled to an inner portion of the wing. The wing lock has a contact surface that contacts an outer portion of the wing to drive the outer portion into alignment with the inner portion. The assembly also includes a linear actuator coupled to the inner portion and to the outer portion, and the linear actuator may selectively apply a downforce to the outer portion and engage the wing lock to drive the contact surface of the wing lock into engagement with the outer portion and to block rotation of the wing lock relative to the inner portion. The wing lock may block rotation of the outer portion relative to the inner portion in response to the contact surface being engaged with the outer portion and rotation of the wing lock being blocked.

### CROSS-REFERENCE TO RELATED APPLICATION

This application claims priority from and the benefit of Brazilian Patent Application No. BR 1020250045605 filed Mar. 11, 2025, which is hereby incorporated by reference in its entirety.

### BACKGROUND

The present disclosure relates generally to a wing lock for an agricultural implement.

Generally, planting implements (e.g., planters) are towed behind a tractor or other work vehicle. Planting implements typically include multiple row units distributed across a width of the planting implement. Each row unit is configured to deposit agricultural product (e.g., seed) at a desired depth beneath the soil surface of a field, thereby establishing rows of planted agricultural product. For example, each row unit typically includes a ground engaging tool or opener that forms a trench for agricultural product (e.g., seed) deposition into the soil. An agricultural product conveying system (e.g., agricultural product tube or powered agricultural product conveyor) is configured to deposit the agricultural product into the trench. The opener/agricultural product conveying system may be followed by closing discs that move displaced soil back into the trench and/or a packer wheel that packs the soil on top of the deposited agricultural product.

The row units may be supported by a tool bar that spans the width of the planting implement. The tool bar may include two wings (e.g., a left wing and a right wing) extending from a tongue assembly, each supporting respective row units, and the tongue assembly may be coupled to a work vehicle, such that the planting implement may be towed behind the work vehicle. Further, each of the two wings may include an inner portion and an outer portion, and the inner portion and outer portion may be pivotally coupled to one another. In addition, a hydraulic cylinder coupled to the inner and outer portions may provide a downforce to the outer portion. For transport of the planting implement, each of the two wings of the tool bar may be folded forwardly to be generally parallel with the tongue assembly. Additionally, pivotal movement between the inner portion and outer portion of each wing may be blocked with a cylinder sleeve to maintain alignment between the portions during the folding process. However, manually locking the inner portion and outer portion with the cylinder sleeve to maintain the alignment may be time-consuming and prone to error (e.g., initiating planting operations without removing the cylinder sleeve).

### SUMMARY

In certain embodiments, a pivotal coupling assembly for a wing of an agricultural implement includes a wing lock pivotally coupled to an inner portion of the wing. The wing lock has a contact surface that contacts an outer portion of the wing to drive the outer portion into alignment with the inner portion. The assembly also includes a linear actuator coupled to the inner portion and to the outer portion, and the linear actuator may selectively apply a downforce to the outer portion and engage the wing lock to drive the contact surface of the wing lock into engagement with the outer portion and to block rotation of the wing lock relative to the inner portion. The wing lock may block rotation of the outer portion relative to the inner portion in response to the contact surface being engaged with the outer portion and rotation of the wing lock being blocked.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units distributed across a width of the agricultural implement;

FIG. 2 is a side view of an embodiment of a pivotal coupling assembly that couples inner and outer portions of a wing and that may be employed on the agricultural implement of FIG. 1;

FIG. 3 is a top view of the pivotal coupling assembly of FIG. 2;

FIG. 4 is a side view of the pivotal coupling assembly of FIG. 2, in which the outer portion is raised during agricultural operations;

FIG. 5 is a side view of the pivotal coupling assembly of FIG. 2, in which the outer portion is lowered during agricultural operations; and

FIG. 6 is a side view of the pivotal coupling assembly of FIG. 2, in which the inner and outer portions are locked into alignment using a wing lock.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

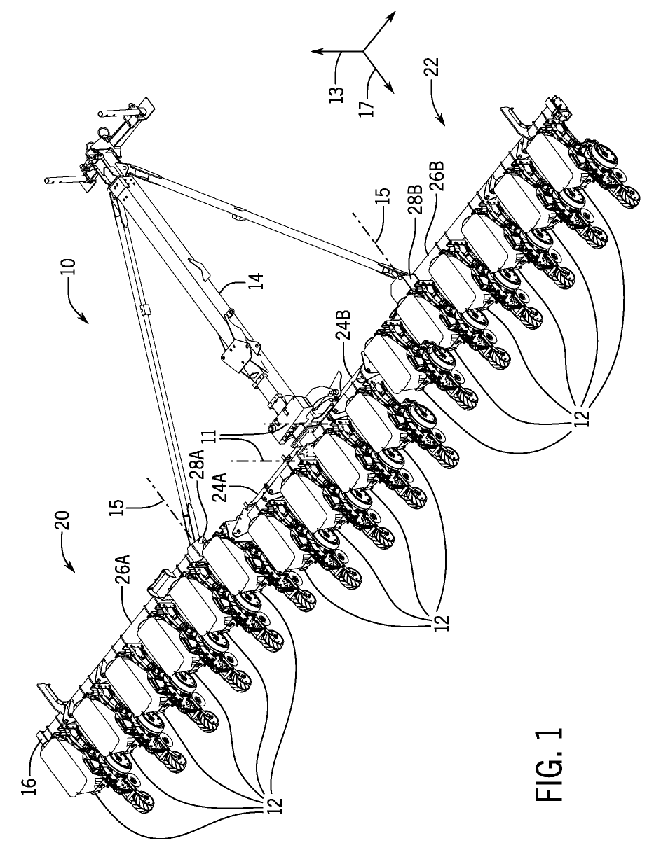

FIG. 1 is a perspective view of an embodiment of an agricultural implement 10 (e.g., planting implement, planter) having multiple row units 12 distributed across a width of the agricultural implement 10. The agricultural implement 10 is configured to be towed through a field behind a work vehicle, such as a tractor. As illustrated, the agricultural implement 10 includes a tongue assembly 14, which includes a hitch configured to couple the agricultural implement 10 to an appropriate tractor hitch (e.g., via a ball, clevis, or other coupling). The tongue assembly 14 is coupled to a tool bar 16 that supports multiple row units 12. Each row unit 12 may include one or more opener discs configured to form a trench within soil of a field. The row unit 12 may also include an agricultural product conveying system (e.g., agricultural product tube or powered agricultural product conveyer) configured to deposit agricultural product (e.g., seed) into the trench. In addition, the row unit 12 may include closing disc(s) and/or a packer wheel positioned behind the agricultural product conveying system. The closing disc(s) are configured to move displaced soil back into the trench, and the packer wheel is configured to pack soil on top of the deposited agricultural product.

Each row unit 12 of the agricultural implement 10 may include a vacuum agricultural product meter and a storage compartment (e.g., hopper, mini-hopper, etc.). In certain embodiments, the storage compartment (e.g., hopper) stores a sufficient amount of agricultural product to complete a desired planting operation. Furthermore, in certain embodiments, the storage compartment (e.g., mini-hopper) is configured to receive agricultural product (e.g., continuously, periodically, on-demand, etc.) from a central storage compartment of the agricultural implement during the planting operation. The vacuum agricultural product meter is configured to control a flow rate of the agricultural product (e.g., seed, fertilizer, other agricultural product, etc.) to the agricultural product conveying system, thereby controlling the flow rate of the agricultural product into the trench. As a result, a desired distribution of the agricultural product throughout the field (e.g., a desired seed spacing along a respective seed row) may be established.

As discussed in detail below, the tool bar 16 includes two wings, a left wing 20, which includes an inner portion 24A and an outer portion 26A, and a right wing 22, which includes an inner portion 24B and an outer portion 26B. The inner portion 24A of the left wing 20 and the inner portion 24B of the right wing 22 are pivotally coupled to the tongue assembly 14 to enable each wing to rotate about a respective rotational axis 11 between an operational position, as illustrated, and a transport position. In the illustrated embodiment, each rotational axis 11 is parallel to a vertical axis 13 of the agricultural implement 10. Each of the inner portions 24 and outer portions 26 supports respective row units 12. In certain embodiments, each inner portion 24 is pivotally coupled to a respective outer portion 26 via a respective pivotal coupling assembly 28 that enables the respective outer portion 26 to rotate about a respective rotational axis 15 relative to the respective inner portion 24. In the illustrated embodiment, each rotational axis 15 is parallel to a longitudinal axis 17 of the agricultural implement 10 while the wings are in the illustrated operational position. Each pivotal coupling assembly 28 includes a hydraulic cylinder coupled (e.g., pivotally coupled) to the respective inner and outer portions, in which the hydraulic cylinder provides downforce to the respective outer portion 26 while the agricultural implement 10 is operating within the field.

For transport of the agricultural implement 10, the left wing 20 and the right wing 22 are folded forwardly from the illustrated operational position to the transport position (e.g., via hydraulic cylinders), such that the wings are generally parallel with the tongue assembly 14. Additionally, each pivotal coupling assembly 28 is configured to maintain alignment of the inner portion 24 and outer portion 26 of each wing during the folding process to substantially reduce or eliminate the possibility of contact between the wings and other parts of the agricultural implement 10. Accordingly, each pivotal coupling assembly 28 includes a wing lock that, based on actuation of the hydraulic cylinder of the pivotal coupling assembly 28, locks the respective inner and outer portions in alignment during the folding process and, in certain embodiments, during the unfolding process of the wings.

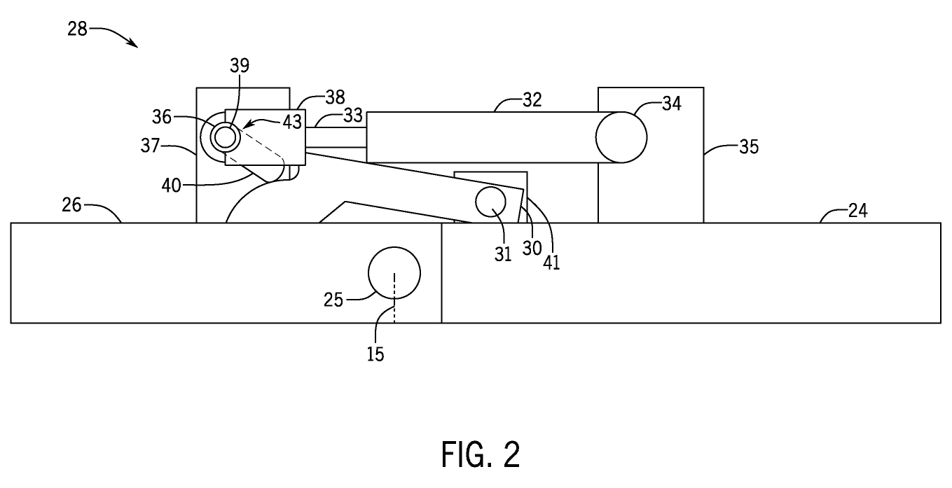

FIG. 2 is a side view of an embodiment of the pivotal coupling assembly 28 that couples the inner portion 24 and the outer portion 26 of a wing and that may be employed on the agricultural implement of FIG. 1. With the wings in the operational position, as shown in FIG. 1, the pivotal coupling assembly 28 does not lock the inner portion and outer portion 26 in alignment. Accordingly, during a planting operation of the agricultural implement (e.g., in a first mode), the outer portion 26 may pivot about the rotational axis 15 relative to the inner portion 24. As illustrated, the inner portion 24 and the outer portion 26 may be pivotally coupled to one another via a pivot joint 25, and the pivot joint 25 enables the outer portion 26 to pivot about the rotational axis 15 with respect to the inner portion 24. As a result, the row units coupled to the inner portion 24 and to the outer portion 26 may follow varying terrain (e.g., due to slopes, bumps, and the like) between the inner portion 24 and the outer portion 26. In addition, the pivotal coupling assembly 28 includes a hydraulic cylinder 32 (e.g., linear actuator) that provides downforce to the outer portion 26 (e.g., to transfer weight from the inner portion and the tongue assembly to the outer portion). The hydraulic cylinder 32 is coupled (e.g., pivotally coupled) to the inner portion 24 via a first rotatable coupling 34 (e.g., including a clevis and a pin) and to the outer portion 26 via a second rotatable coupling 36 (e.g., including a clevis and a pin). During the planting operation, hydraulic fluid may be provided to the cap end of the hydraulic cylinder 32, which urges a piston rod 33 of the hydraulic cylinder 32 to extend, thereby urging the outer portion 26 to rotate downwardly about the rotational axis 15 with respect to the inner portion 24. In the illustrated embodiment, the first rotatable coupling 34 is coupled to a first mount 35 of the inner portion 24, and the second rotatable coupling 36 is coupled to a second mount 37 of the outer portion 26. However, in other embodiments, at least one of the first mount or the second mount may be omitted (e.g., at least one rotatable coupling may be coupled to a body of the respective portion). Furthermore, while the pivotal coupling assembly 28 includes a hydraulic cylinder in the illustrated embodiment, in other embodiments, the pivotal coupling assembly may include another suitable linear actuator (e.g., pneumatic cylinder, electric linear actuator, etc.).

The pivotal coupling assembly 28 includes one or more wing locks 30 that are pivotally coupled to the inner portion 24 via respective pivotal couplings 31. The second rotatable coupling 36 includes a pin 39 configured to engage the wing lock(s) 30, thereby locking the inner portion 24 and the outer portion 26 in alignment, as will be described in more detail below. The second rotatable coupling 36 also includes a clevis 38 that forms a distal end of the piston rod 33 of the hydraulic cylinder 32, which supports the pin 39. The pin 39 is configured to contact the second mount 37 as the piston rod 33 is urged to extend, thereby exerting a force (e.g., the downforce) on the outer portion 26. In the illustrated embodiment, the pivotal coupling(s) 31 are coupled to respective third mount(s) 41 of the inner portion 24. However, in certain embodiments, at least one third mount may be omitted (e.g., at least one pivotal coupling may be coupled to a body of the inner portion).

A slot 40 within the second mount 37 enables the pin 39 of the second rotatable coupling 36 to move (e.g., slide) to engage the wing lock(s) 30 for locking the inner portion 24 and the outer portion 26 into alignment. As previously discussed, during the planting operation, hydraulic fluid is applied to the cap end of the hydraulic cylinder 32. Accordingly, the piston rod 33 is driven to extend until the pin 39 reaches a first end 43 of the slot 40. Once the pin 39 reaches the first end 43 of the slot 40, contact between the pin 39 and the second mount 37 urges the outer portion 26 to rotate downwardly about the rotational axis 15 relative to the inner portion 24, thereby applying the downforce to the outer portion 26. Furthermore, to lock the first and second portions into alignment (e.g., prior to rotation of the wings from the operational position to the transport position), hydraulic fluid is applied to the rod end of the hydraulic cylinder 32, thereby driving the piston rod 33 to retract, which drives the pin 39 toward a second end of the slot 40. Contact between the pin 39 and the wing lock(s) 30 drives the outer portion 26 to rotate into alignment with the inner portion 24 and locks the inner and outer portions into alignment.

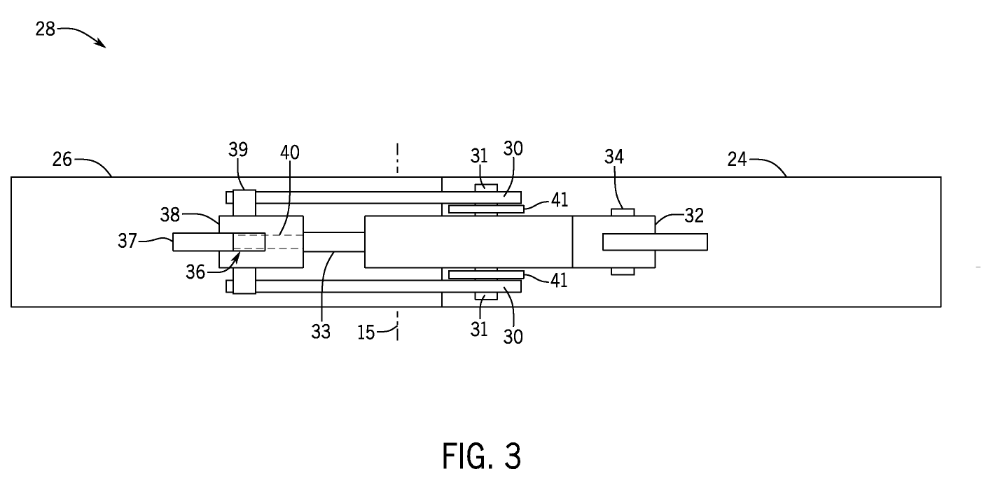

To illustrate further, FIG. 3 is a top view of the pivotal coupling assembly 28 of FIG. 2. In the illustrated embodiment, the pivotal coupling assembly 28 includes two wing locks. However, in other embodiments, the pivotal coupling assembly may include more or fewer wing locks 30. As illustrated, the wing locks 30 are pivotally coupled to the respective third mounts 41 of the inner portion 24, which are positioned on opposite lateral sides of the hydraulic cylinder 32, via respective pivotal couplings 31. In addition, the pin 39, which is part of the rotatable coupling 36, extends through the clevis 38, which forms the distal end of the piston rod 33 of the hydraulic cylinder 32, and through the slot 40 within the second mount 37. As illustrated, the pin 39 extends at least as far as the wing locks 30, which enables the locked alignment of the inner portion 24 and the outer portion 26. For example, as the pin 39 moves along the slot 40 toward the second end due to retraction of the piston rod 33, the pin 39 may contact the wing locks 30, thereby driving the outer portion 26 to rotate into alignment with the inner portion 24 and locking the inner and outer portions into alignment. However, during the planting operation, the pin 39 may be positioned at the first end of the slot 40, thereby enabling the outer portion 26 to pivot about the rotational axis 15 relative to the inner portion 24.

While the second rotatable coupling 36 includes one pin 39 in the illustrated embodiment, in other embodiments, the second rotatable coupling may include multiple pins coupled to the clevis (e.g., a first pin disposed within the slot, a second pin configured to engage the first wing lock, and a third pin configured to engage the second wing lock). Furthermore, while the outer portion 26 includes one second mount 37 in the illustrated embodiment, in other embodiments, the outer portion may include multiple second mounts (e.g., positioned on opposite lateral sides of the hydraulic cylinder), in which each second mount has a respective slot configured to receive the pin(s). For example, one second mount may be positioned laterally outwardly from the first wing lock, and another second mount may be positioned laterally outwardly from the second wing lock.

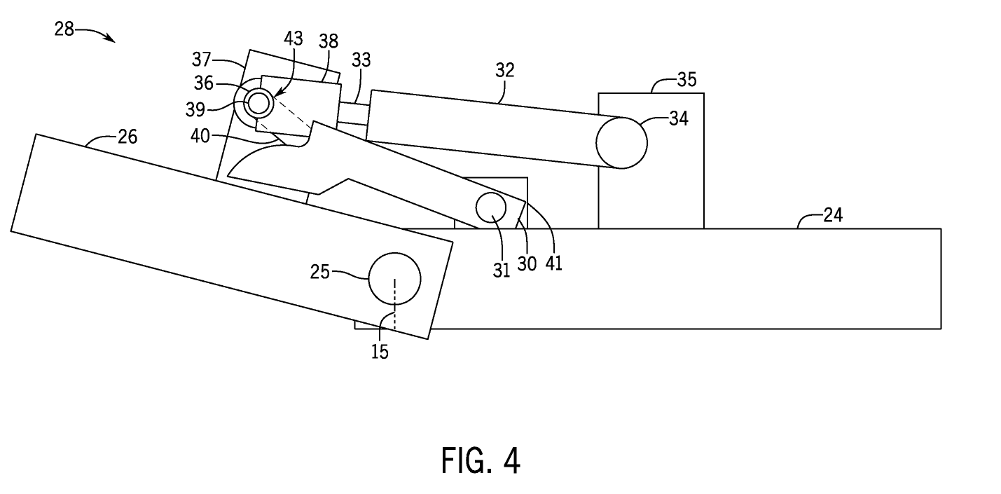

FIG. 4 is a side view of the pivotal coupling assembly 28 of FIG. 2, in which the outer portion 26 is raised with respect to the inner portion 24 during agricultural operations. The outer portion 26 may be raised in response to the outer portion 26 traversing ground that is higher than ground traversed by the inner portion 24 (e.g., on a slope, hill, bumpy terrain). The upward force applied to the outer portion 26 may be greater than the downforce applied by the hydraulic cylinder 32 and downforce caused by the weight of the outer portion 26 and the row units coupled to the outer portion, thereby driving the piston rod 33 of the hydraulic cylinder 32 to retract. The hydraulic cylinder 32 may maintain the downforce due to the hydraulic fluid supplied to the cap end of the hydraulic cylinder. Due to the force applied by the hydraulic cylinder 32, the pin 39 of the rotatable coupling 36 may maintain contact with the second mount 37 at the first end 43 of the slot 40, thereby establishing a separation between the pin 39 and the wing lock(s) 30. As such, while hydraulic fluid is supplied to the cap end of the hydraulic cylinder 32, the wing lock 30 may not restrict rotation of the outer portion 26 about the rotational axis 15 relative to the inner portion 24 in response to variations in the terrain traversed by the agricultural implement. Furthermore, because the wing lock(s) 30 are pivotally coupled to the inner portion, contact between the body of the outer portion 26 and the wing lock(s) 30 drives the wing lock(s) 30 to pivot upwardly in response to upward pivotal movement of the outer portion 26.

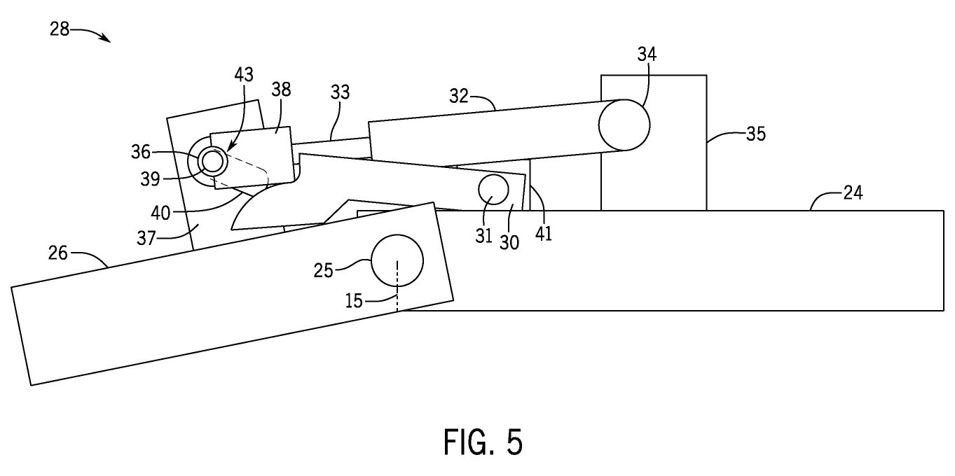

FIG. 5 is a side view of the pivotal coupling assembly 28 of FIG. 2, in which the outer portion 26 is lowered with respect to the inner portion 24 during agricultural operations. The outer portion 26 may be lowered in response to the outer portion 26 traversing ground that is lower than ground traversed by the inner portion 24. As the outer portion 26 pivots downwardly with respect to the inner portion 24, the hydraulic cylinder 32 maintains the downforce due to the hydraulic fluid supplied to the cap end of the hydraulic cylinder. Due to the force applied by the hydraulic cylinder 32, the pin 39 of the rotatable coupling 36 may maintain contact with the second mount 37 at the first end 43 of the slot 40, thereby establishing separation between the pin 39 and the wing lock(s) 30. As such, while hydraulic fluid is supplied to the cap end of the hydraulic cylinder 32, the wing lock(s) 30 may not restrict rotation of the outer portion 26 about the rotational axis 15 relative to the inner portion 24 in response to the terrain traversed by the agricultural implement. Furthermore, because the wing lock(s) 30 are pivotally coupled to the inner portion, gravity may drive the wing lock(s) 30 to pivot downwardly in response to downward pivotal movement of the outer portion 26.

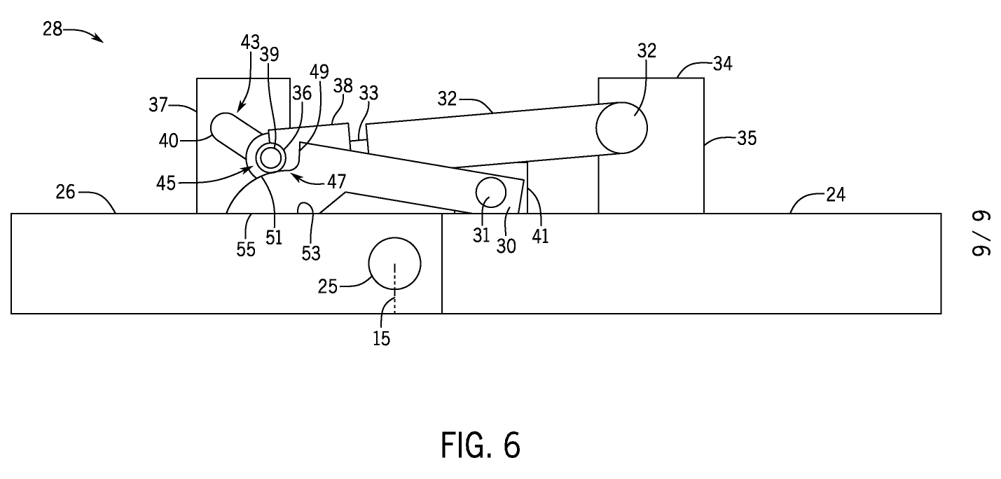

FIG. 6 is a side view of the pivotal coupling assembly 28 of FIG. 2, in which the inner and outer portions are locked into alignment using the wing lock 30. As illustrated, the pin 39 of the second rotatable coupling 36 is engaged with the wing lock(s) 30 (e.g., in a locked arrangement). To enter the locked arrangement (e.g., a second mode), hydraulic fluid is supplied to the rod end of the hydraulic cylinder 32, thereby driving the piston rod 33 to retract (e.g., such that the overall length of the hydraulic cylinder is decreased). Hydraulic fluid flow to the rod end and to the cap end of the hydraulic cylinder 32 may be controlled via a valve (e.g., manually control valve, actuator-controlled valve, etc.). In response to retraction of the piston rod 33, the pin 39 moves along the slot 40 toward the second end 45 until the pin 39 engages the wing lock(s) 30. Once the pin 39 is engaged with the wing lock(s) 30, the hydraulic cylinder 32 may be locked (e.g., by blocking hydraulic fluid flow to the rod end and/or the cap end of the hydraulic cylinder), or hydraulic fluid may be supplied to the rod end. As such, extension of the piston rod 33 of the hydraulic cylinder 32 is substantially blocked, thereby blocking rotation of the wing lock(s) 30, which blocks rotation of the outer portion 26 about the rotational axis 15 relative to the inner portion 24.

As illustrated, each wing lock 30 includes a recess 47 configured to capture the pin 39 in the locked arrangement. In addition, each wing lock 30 includes a first angled surface 49 and a second angled surface 51. Each angled surface is configured to guide the pin 39 toward the recess 47 as the piston rod 33 retracts. Furthermore, each wing lock 30 includes a contact surface 53 configured to contact the body of the outer portion 26. In the illustrated embodiment, the contact surface 53 is substantially flat to engage a substantially flat upper surface 55 of the body of the outer portion 26. However, in other embodiments, the contact surface may have another suitable shape (e.g., corresponding to the shape of the upper surface of the body of the outer portion). If the piston rod 33 of the hydraulic cylinder 32 is retracted while the outer portion 26 is pivoted downwardly, as shown in FIG. 5, the pin 39 may contact the first angled surface 51, which may drive the pin to move toward the recess 47. As the pin 39 moves toward the recess 47, contact between the pin 39 and the first angled surface 51 drives the wing lock 30 to rotate to the illustrated locked orientation. In addition, contact between the contact surface 53 of the wing lock 30 and the upper surface 55 of the body of the outer portion 26 drives the outer portion 26 to rotate into alignment with the inner portion 24, as illustrated. Furthermore, if the piston rod 33 of the hydraulic cylinder 32 is retracted while the outer portion 26 is pivoted upwardly, as shown in FIG. 4, the pin 39 may contact the second angled surface 49, which may drive the pin to move toward the recess 47. As the pin 39 moves toward the recess 47, contact between the pin and the second angled surface 49 drives the wing lock 30 to rotate to the illustrated locked orientation. In addition, contact between the contact surface 53 of the wing lock 30 and the upper surface 55 of the body of the outer portion 26 drives the outer portion 26 to rotate into alignment with the inner portion 24, as illustrated. Accordingly, retraction of the piston rod 33 may drive the wing lock(s) 30 to drive the outer portion 26 into alignment with the inner portion 24.

Additionally, with the pin 39 engaged with the recess 47 of each wing lock 30, as illustrated, and extension of the piston rod 33 of the hydraulic cylinder 32 substantially blocked, rotation of the wing lock(s) 30 relative to the inner portion is substantially blocked. With rotation of the wing lock(s) 30 substantially blocked, engagement between the contact surface 53 of each wing lock 30 and the upper surface 55 of the body of the outer portion 26 blocks rotation of the outer portion 26 about the rotational axis 15 relative to the inner portion 24. To exit the illustrated locked arrangement, hydraulic fluid may be supplied to the cap end of the hydraulic cylinder 32, thereby driving the piston rod 33 to extend, which disengages the pin 39 from the wing lock(s) 30. As a result, rotation of the outer portion 26 about the rotational axis 15 relative to the inner portion 24 is enabled. While the pivotal coupling assembly is disclosed above with respect to portions of one wing of the agricultural planting implement, in certain embodiments, the other wing of the agricultural planting implement may include a pivotal coupling assembly having the configuration disclosed above. Furthermore, while the pivotal coupling assembly is disclosed above with regard to an agricultural planting implement, the pivotal coupling assembly may be employed within any other suitable agricultural implement having at least one wing with at least two portions, such as a seeding implement, a sprayer, a tillage implement, etc. In addition, while the slot 40 is shown as oriented at a certain angle, the slot 40 may be oriented at any suitable angle relative to the outer portion 26. Further, while the slot 40 is shown as straight, in some embodiments, the slot 40 may be curved, bent, or of another suitable shape.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A pivotal coupling assembly for a wing of an agricultural implement, comprising:
a wing lock pivotally coupled to an inner portion of the wing, wherein the wing lock has a contact surface configured to contact an outer portion of the wing to drive the outer portion into alignment with the inner portion; and
a linear actuator coupled to the inner portion of the wing and to the outer portion of the wing, and configured to selectively:
apply a downforce to the outer portion of the wing to urge the outer portion to rotate relative to the inner portion; and
engage the wing lock to drive the contact surface of the wing lock into engagement with the outer portion of the wing and to block rotation of the wing lock relative to the inner portion;
wherein the wing lock is configured to block rotation of the outer portion relative to the inner portion in response to the contact surface being engaged with the outer portion and rotation of the wing lock being blocked.

2. The pivotal coupling assembly of claim 1, wherein the inner portion comprises a mount, and the linear actuator is configured to couple to the mount of the inner portion via a rotatable coupling.

3. The pivotal coupling assembly of claim 1, wherein the linear actuator comprises a clevis and a pin coupled to the clevis, and the pin is configured to engage the wing lock.

4. The pivotal coupling assembly of claim 3, wherein the outer portion comprises a mount having a slot, and the pin is configured to be disposed within the slot.

5. The pivotal coupling assembly of claim 3, wherein the wing lock comprises a recess, and the pin is configured to engage the recess of the wing lock.

6. The pivotal coupling assembly of claim 5, wherein the wing lock comprises an angled surface configured to guide the pin toward the recess.

7. The pivotal coupling assembly of claim 1, wherein the linear actuator comprises a hydraulic cylinder.

8. The pivotal coupling assembly of claim 1, wherein the contact surface of the wing lock has a first shape, the first shape corresponding to a second shape of the outer portion of the wing.

9. The pivotal coupling assembly of claim 1, wherein the contact surface of the wing lock is configured to contact an upper surface of the outer portion.

10. A wing of an agricultural implement, comprising:
an inner portion;
an outer portion;
a pivotal coupling assembly configured to pivotally couple the inner portion and the outer portion, comprising:
a wing lock pivotally coupled to the inner portion, wherein the wing lock has a contact surface configured to contact the outer portion to drive the outer portion into alignment with the inner portion; and
a linear actuator coupled to the inner portion and to the outer portion, and configured to selectively:
apply a downforce to the outer portion to urge the outer portion to rotate relative to the inner portion; and
engage the wing lock to drive the contact surface of the wing lock into engagement with the outer portion and to block rotation of the wing lock relative to the inner portion;
wherein the wing lock is configured to block rotation of the outer portion relative to the inner portion in response to the contact surface being engaged with the outer portion and rotation of the wing lock being blocked.

11. The wing of claim 10, wherein the inner portion and the outer portion are configured to support respective row units of the agricultural implement.

12. The wing of claim 10, wherein the outer portion to rotate relative to the inner portion on a first axis of rotation, and wherein the wing is configured to rotate relative to a tongue assembly of the agricultural implement on a second axis of rotation.

13. The wing of claim 10, wherein the linear actuator comprises a clevis and a pin coupled to the clevis, wherein the outer portion comprises a mount having a slot, and wherein the pin is configured to be disposed within the slot.

14. The wing of claim 13, wherein the slot is angled towards the wing lock, and wherein the pin is configured to engage the wing lock by sliding along the slot.

15. The wing of claim 10, wherein the inner portion comprises a mount, and the linear actuator is configured to couple to the mount of the inner portion via a rotatable coupling.

16. A pivotal coupling assembly for a wing of an agricultural implement, comprising:
a wing lock pivotally coupled to an inner portion of the wing, wherein the wing lock has a contact surface configured to contact an outer portion of the wing to drive the outer portion into alignment with the inner portion; and
a hydraulic cylinder coupled to the inner portion of the wing and to the outer portion of the wing, comprising a clevis and a pin coupled to the clevis, the hydraulic cylinder configured to selectively:
apply a downforce to the outer portion of the wing to urge the outer portion to rotate relative to the inner portion; and
engage the pin with the wing lock to drive the contact surface of the wing lock into engagement with the outer portion of the wing and to block rotation of the wing lock relative to the inner portion;
wherein the wing lock is configured to block rotation of the outer portion relative to the inner portion in response to the contact surface being engaged with the outer portion and rotation of the wing lock being blocked.

17. The pivotal coupling assembly of claim 16, wherein the inner portion comprises a mount, and the hydraulic cylinder is configured to couple to the mount of the inner portion via a rotatable coupling.

18. The pivotal coupling assembly of claim 16, wherein the wing lock comprises a recess, and the pin is configured to engage the recess of the wing lock.

19. The pivotal coupling assembly of claim 18, wherein the wing lock comprises an angled surface configured to guide the pin toward the recess.

20. The pivotal coupling assembly of claim 16, wherein the contact surface of the wing lock is configured to contact an upper surface of the outer portion.
